(19) United States
(12) Patent Application Publication
(10) Pub. No.: US 2026/0074818 A1
(43) Pub. Date: Mar. 12, 2026

(54) Ultra-Wideband Wavelength Reference and Use Thereof in a Wavelength Division Multiplexing System

(71) Applicant: II-VI Delaware, Inc., Wilmington, DE (US)

(72) Inventors: Michael Cahill, Hampton (AU); Glenn D. Bartolini, Lexington, MA (US)

(21) Appl. No.: 18/883,553

(22) Filed: Sep. 12, 2024

(51) Int. Cl. H04J 14/02

(52) U.S. Cl. CPC H04J 14/0227

(57) ABSTRACT

A wavelength reference (WLREF) includes a number of individual spectral band sources, each of which outputs a different spectral band than each other spectral band source. One or more combiners combine the different spectral bands into a WLREF broadband optical signal that is output to an optical channel monitor (OCM) which compares at least one broadband optical signals that also includes different spectral bands, sampled by the OCM from at least one transmission optical fiber to the WLREF broadband optical signal, determines from the comparison if one or more parameters of the at least one broadband optical signal sampled from the transmission optical fiber is/are operating outside of a predetermined tolerance or range, and, if so, causes the one or more parameters of the broadband optical signal to be adjusted whereupon the broadband optical signal is operating within the predetermined tolerance or range.

### BACKGROUND

### 1) Field

The present disclosure relates to an ultra-wideband wavelength reference, wavelength division multiplexing systems (WDMs) systems that include the ultra-wideband wavelength reference, and a method of use thereof.

### 2) Background

A trend for future generations of optical transmission systems is to use additional spectral bands available in optical fiber. Optical devices that require a wavelength reference (WLREF) to maintain accuracy, such as Optical Channel Monitors (OCM), need to support these additional spectral bands.

Heretofore, wavelength references (WLREF) utilized a broadband optical source connected to a spectral filter to generate one or more spectral characteristics that are stable over time and temperature that can be used as independent references of wavelength. A WLREF used for a C-band or L-band system typically uses a super-luminescent light-emitting diode (SLED) coupled with one or more notch filters or an etalon filter. The bandwidth of a typical SLED is limited to about 40 nm to 60 nm, with some supporting operation over up to about 80 nm bandwidth.

To support spectral bands wider than the SLED spectral bandwidth, or to support multiple optical channel monitors (OCMs) that support the C- or L-bands, the current state-of-art uses separate WLREFs with SLEDs coupled to their own spectral filters. This adds additional size, complexity, and cost as compared to a single WLREF.

It would, therefore, be desirable to extend current WLREF technology to support additional spectral bands while avoiding additional cost and size.

### SUMMARY

Disclosed herein is a wavelength reference (WLREF) comprising a plurality of individual spectral band sources. Each spectral band source may be programmed, operative and/or configured for outputting a different spectral band than each other spectral band source. The WLREF may include one or more combiners programmed, operative and/or configured for combining the different spectral band into a broadband optical signal and for outputting the broadband optical signal.

Also disclosed herein is a method of using a wavelength division multiplexing (WDM) system that includes first and second optical communication signals co-propagating on a single optical fiber or propagating separately on separate optical fibers, and at least one optical channel monitor (OCM) programmed, operative and/or configured to sample the first and second optical communication signals. The method may comprise: (a) sampling, by the OCM from the one or more optical fibers, the first and second optical communication signals having wavelengths in respective first and second spectral bands; (b) receiving by the OCM, from a wavelength reference (WLREF), the first and second spectral bands; (c) comparing, by the OCM, the first and second optical communication signals sampled in step (a) with the respective first and second spectral bands received in step (b); (d) based on the comparison in step (c), determining, by the OCM, if one or more parameters of each of the first and second optical communication signals is operating outside of a predetermined tolerance or range of the one or more parameters for the optical communication signal; and (e) for each of the first and second optical communication signals determined to be operating outside of the predetermined tolerance or range of the one or more parameters for the optical communication signal in step (d), adjusting the one or more parameters of the optical communication signal sampled by the OCM whereupon the optical communication signal is operating within the predetermined tolerance or range of the one or more parameters of the optical communication signal.

Also disclosed herein is a wavelength division multiplexing (WDM) system comprising first and second optical transmitters outputting into an input end of one or more optical fibers first and second optical communication signals having wavelengths in respective first and second spectral bands. The WDM system may include first and second optical receivers receiving the first and second optical communication signals. At least one optical channel monitor (OCM) may be optically coupled to the one or more optical fibers. The OCM may be programmed, operative and/or configured for sampling from the one or more optical fibers the first and second optical communication signals. A wavelength reference (WLREF) may be optically coupled to the OCM. The WLREF may be programmed, operative and/or configured for outputting to the OCM the first and second spectral bands. The OCM may be programmed, operative and/or configured for comparing the first and second optical communication signals sampled by the OCM with the respective first and second spectral bands. The OCM may be programmed, operative and/or configured for determining from the comparison if one or more parameters of each of the first and second optical communication signals is operating outside of a predetermined tolerance or range of the one or more parameters of the optical communication signal. For each of the first and second optical communication signals determined by the OCM to be operating outside of the predetermined tolerance or range of the one or more parameters of the optical communication signal, the one or more parameters of the optical communication signal sampled by the OCM may be adjusted whereupon the optical communication signal is operating within the predetermined tolerance or range of the one or more parameters of the optical communication signal.

Also disclosed is wavelength division multiplexing (WDM) system comprising a wavelength selective switch (WSS) optically coupled between first and second optical fiber bundles. A first optical channel monitor (OCM1) may be programmed, operative and/or configured for sampling a first set of optical communication signals having a first set of wavelengths in a first set of spectral bands propagating on a first set of optical fibers of the first optical fiber bundle. A second optical channel monitor (OCM2) may be programmed, operative and/or configured for sampling a second set of optical communication signals having a second set of wavelengths in a second set of spectral bands propagating on a second set of optical fibers of the second optical fiber bundle. A wavelength reference (WLREF) may be optically coupled to the OCM1 and the OCM 2. The WLREF may be programmed, operative and/or configured for outputting to the OCM1 and the OCM2 the first and second sets of spectral bands. The OCM1 may be programmed, operative and/or configured for comparing the first set of optical communication signals with the first set of spectral bands and for determining from the comparison if one or more parameters of the first set of optical communication signals is operating outside of a predetermined tolerance or range of a set of parameters of the first set of optical communication signals. In response to the OCM1 determining that the first set of optical communication signals is operating outside of the predetermined tolerance or range of the set of parameters of the first set of optical communication signals, the set of parameters of the first set of optical communication signals may be adjusted whereupon the first set of optical communication signals is operating within the predetermined tolerance or range of the set of parameters of the first set of optical communication signals. The OCM2 may be programmed, operative and/or configured for comparing the second set of optical communication signals with the second set of spectral bands and for determining from the comparison if one or more parameters of the second set of optical communication signals is operating outside of a predetermined tolerance or range of a set of parameters of the second set of optical communication signals. In response to the OCM2 determining that the second set of optical communication signals is operating outside of the predetermined tolerance or range of the set of parameters of the second set of optical communication signals, the set of parameters of the second set of optical communication signals may be adjusted whereupon the second set of optical communication signals is operating within the predetermined tolerance or range of the set of parameters of the second set of optical communication signals.

### BRIEF DESCRIPTION OF THE DRAWINGS

FIG. 1 (top) is a schematic of a non-limiting embodiment or example wavelength reference (WLREF), in accordance with principles of the present disclosure, that, in some non-limiting embodiments or examples, may include a number, e.g., four, spectral band sources that, in an example, may generate or output these spectral bands as shown at the bottom of FIG. 1;

FIGS. 2 and 3 are wavelength division multiplexing (WDM) systems, in accordance with principles of the present disclosure, that include the WLREF of FIG. 1; and

FIG. 4 is a method in accordance with principles of the present disclosure.

### DETAILED DESCRIPTION

Various non-limiting embodiments will now be described with reference to the accompanying figures where like reference numbers correspond to like or functionally equivalent elements.

As used herein, spatial, or directional terms, such as “left”, “right”, “inner”, “outer”, “above”, “below”, and the like, relate to the disclosure as it is shown in the drawing figures. However, it is to be understood that the disclosure can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “approximately” or “about”. Accordingly, unless indicated to the contrary, the numerical values set forth in the following specification and claims may vary depending upon the desired properties sought to be obtained by the present disclosure.

At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. “A” or “an” refers to one or more.

As used herein, "coupled", "coupling", and similar terms refer to two or more elements that are joined, linked, fastened, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the phrase "at least one of", when used with a list of items, means different combinations of one or more of the listed items may be used and only one of each item in the list may be needed. For example, "at least one of item A, item B, and item C" may include, without limitation, item A or item A and item B. This example also may include item A, item B, and item C, or item B and item C. In other examples, "at least one of" may be, for example, without limitation, two of item A, one of item B, and ten of item C; four of item B and seven of item C; and other suitable combinations.

As used herein, the term “set” may comprise one or more elements. For example, without limitation. a set of optical communication signals may include one or more optical communication signals; a set of wavelengths may include one or more wavelengths; a set of spectral bands may include one or more spectral bands; a set of optical fibers may include one or more optical fibers; a set of parameters may include one or more parameters; a set of inputs may include one or more inputs; and a set of outputs may include one or more outputs.

In this disclosure, each item, element, circuit and/or system described as being “programmed, operative and/or or configured” may be formed of:

(1) one or more discrete passive optical and/or electrical components, such as, without limitation, optical waveguide(s), resistor(s), capacitor(s), inductor(s), transistor(s), op-amp(s), and the like in some combination thereof as determined by the application; or

(2) one or more controller(s), processor(s), memory, storage component(s), an input component, an output component, and a communication interface, all connected by a bus in some combination thereof as determined by the application; or

(3) some combination of (1) and (2) as determined by the application.

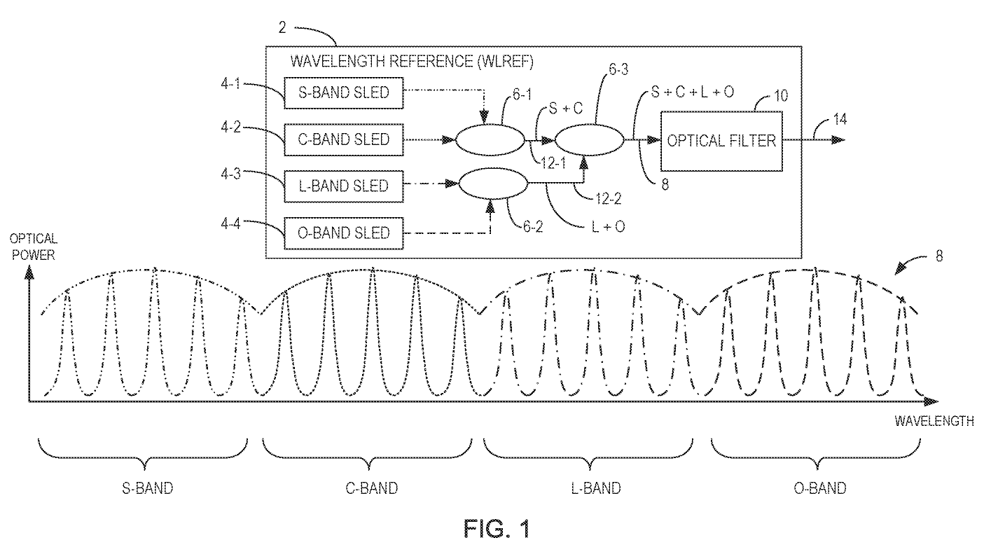

With reference to FIG. 1, in some non-limiting embodiments or examples, a wavelength reference (WLREF) 2 in accordance with principles of the present disclosure may include a plurality of individual spectral band sources 4, each programmed, operative and/or configured for outputting a different spectral band. In an example, each spectral band source 4 may be comprised of a super-luminescent light-emitting diode (SLED). However, this is not to be construed in a limiting sense since it is envisioned that each spectral band source 4 may be comprised of any suitable and or desirable light source that is capable outputting a desired spectral band.

In some non-limiting embodiments or examples, the WLREF 2 may include four spectral band sources, for example, an S-band source 4-1, a C-band source 4-2, an L-band source 4-3, and an O-band source 4-4. However, this is not to be construed in a limiting sense since it is envisioned that the WLREF 2 may include any number of spectral band sources, including two, three or more spectral band sources 4, each generating light in a unique spectral band, such as, for example, the S, C, L and/or O spectral bands and/or any other spectral band(s). In this disclosure, each spectral “band source” 4 may also or alternatively be considered or referred to as a “broadband source”. Therefore, in connection with each spectral “band” source 4 in this disclosure, the terms “band source” and "broadband source” may be used interchangeably.

The example WLREF 2 shown in FIG. 1 may also include a plurality of optical combiners 6, each of which may be programmed, operative and/or configured for combining the different spectral bands into a broadband optical signal 8 and for outputting this broadband optical signal 8 to an optical filter 10.

The example WLREF 2 shown in FIG. 1 may include three optical combiners 6-1, 6-2, and 6-3. In this example, the optical combiner 6-1 may be programmed, operative and/or configured for combining the outputs of the S-band source 4-1 and the C-band source 4-2 into a broadband optical signal 12-1 that includes both the S-band and the C-band (S+C). Continuing with this example, the optical combiner 6-2 may be programmed, operative and/or configured for combining the outputs of the L-band source 4-3 and the O-band source 4-4 into a broadband optical signal 12-2 that includes both the L-band and the O-band (L+O). Finally, in this example, the optical combiner 6-3 may combine the broadband optical signals 12-1 and 12-2 output from the optical combiners 6-1 and 6-2 into the broadband optical signal 8 that includes the S-band, the C-band the L-band, and the O-band (S+C+L+O) that is output as a WLREF broadband optical signal 14 via the optical filter 10.

The example shown in FIG. 1 and described above, however, is not to be construed in a limiting sense since it is envisioned that, in an example, the WLREF 2 may include any number of two or more optical combiners 6 that may be programmed, operative and/or configured for combining the optical outputs of any number of two or more spectral band sources 4 into the broadband optical signal 8 that the optical filter 10 may optically filter and output as the WLREF broadband optical signal 14. In an example, the optical filter 10 may comprise one or more notch filters, an etalon filter, or some combination thereof. However, is not to be construed in a limiting sense.

Continuing with this example, as shown at the bottom of FIG. 1, the WLREF broadband optical signal 14 that is output by the optical filter 10 may include the S-spectral band, the C-spectral band, the L-spectral band, and the O-spectral band. However, is not to be construed in a limiting sense since the WLREF broadband optical signal 14 output by the optical filter 10 may include any combination of two or more spectral bands that may be input into the optical filter 10. In an example, each spectral band may comprise 85, 90, 95, or more channels, i.e., each spectral band may be considered or referred to as a “broadband” source that comprises a plurality of channels.

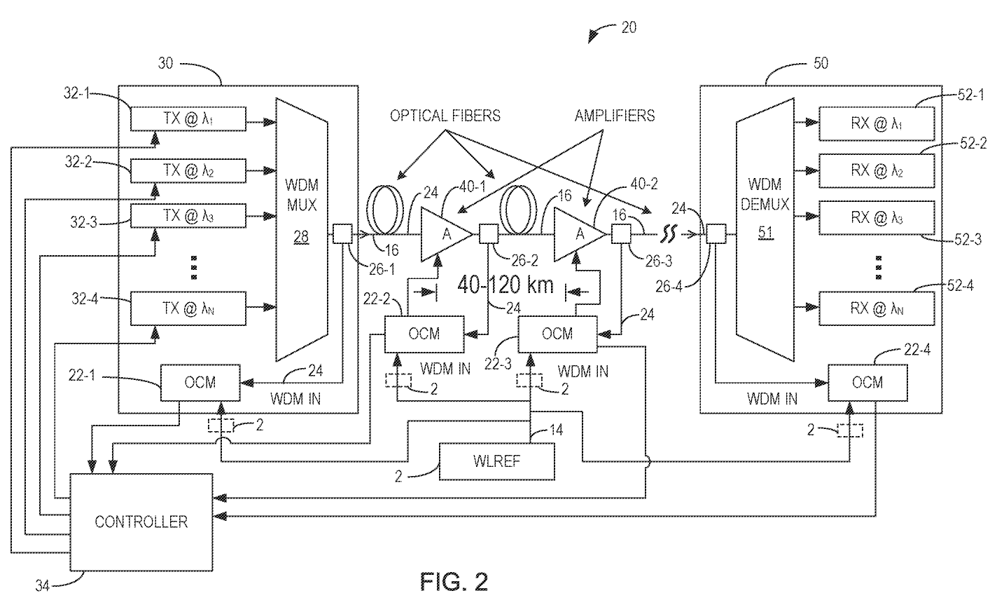

With reference to FIG. 2 and with continuing reference to FIG. 1, in some non-limiting embodiments or examples, a wavelength division multiplexing (WDM) system 20 in accordance with the principles of the present disclosure may include the WLREF 2 of FIG. 1 outputting the WLREF broadband optical signal 14 to one or more optical channel monitors (OCMs) 22. Each OCM 22 may be programmed, operative and/or configured for sampling and comparing each spectral band comprising the WLREF broadband optical signal 14 with an optical communication signal or channel having a wavelength in the same spectral band as the sampled spectral band.

In an example, an OCM 22-1 may be programmed, operative and/or configured to sample the WLREF broadband optical signal 14 output by the WLREF 2 and to also sample an optical communication signal or broadband optical signal 24 output to a transmission optical fiber 16, which may comprise one or more optical fibers, by a wavelength division multiplexer (WDM MUX) 28 of an optical transmitter block 30 to the OCM 22-1 via an optical splitter 26-1. Herein, the terms “optical communication signal” and “broadband optical signal” may be used interchangeably.

In an example, the WDM MUX 28 may multiplex or combine the output of a number of optical transmitters 32 of the optical transmitter block 30 operating at different spectral bands, each of which may include one or more channels having data modulated thereon. In an example, optical transmitters 32-1 – 32-4 may output the respective S-band, C-band, L-band, and O-band spectral bands to the WDM MUX 28 which multiplexes or combines these bands into the broadband optical signal 24. However, this is not to be construed in a limiting sense.

In an example, the OCM 22-1 may be programmed, operative and/or configured for sampling and comparing one or more or each spectral band comprising the WLREF broadband optical signal 14 with the broadband optical signal 24 and/or one or more channels thereof that may have a wavelength channel in the same spectral band. In response to determining from the comparison that the broadband optical signal 24 and/or one or more channels thereof is operating outside of a predetermined tolerance or range, the OCM 22-1 may output a signal that causes the one or more parameters of the broadband optical signal 24 and/or one or more channels thereof sampled by the OCM 22-1 to be adjusted to be operating within the predetermined tolerance or range. In an example, the predetermined tolerance or range of the broadband optical signal 24 and/or one or more channels thereof and the one or more parameters to be adjusted may include an optical frequency, e.g., an optical frequency offset from a desired optical frequency, an optical power, e.g., an optical power offset from a desired optical power, a spectral power tilt, e.g., a spectral power tilt offset from a desired spectral power tilt, or some combination of the optical frequency, the optical power and/or the spectral power tilt of one or more of the channels and/or spectral bands of the broadband optical signal 24.

In one example, the OCM 22-1 may output this signal to a processor or controller 34 that may be programmed, operative and/or configured to, in response to this signal, cause the operation of the appropriate optical transmitter 32 to be adjusted whereupon the one or more parameters of the broadband optical signal 24 and/or one or more channels thereof is/are operating within the predetermined tolerance or range. For example, assuming the OCM 22-1 determines that the S-band output by transmitter 32-1 is operating outside of a predetermined tolerance or range, the controller 34, in response to the signal of this event or condition output to the controller 34 by the OCM 22-1, may cause the operation of transmitter 32-1 to be adjusted whereupon the one or more parameters of the S-band output by transmitter 32-1 sampled by the OCM 22-1 is adjusted to be operating within the predetermined tolerance or range.

In another example, an OCM 22-2 may be programmed, operative and/or configured to sample the WLREF broadband optical signal 14 output by the WLREF 2 and to also sample the broadband optical signal 24 output by an optical amplifier 40-1 to the OCM 22-2 via an optical splitter 26-2 after transmission of the broadband optical signal 24 along the transmission optical fiber 16 for amplification by the optical amplifier 40-1.

In this example, like the previous example described in connection with OCM 22-1, the OCM 22-2 may be programmed, operative and/or configured for sampling and comparing one or more or each spectral band comprising the WLREF broadband optical signal 14 with the broadband optical signal 24 and/or one or more channels thereof that may have a wavelength channel in the same spectral band. In response to determining from the comparison that the broadband optical signal 24 and/or one or more channels thereof is operating outside of a predetermined tolerance or range, the OCM 22-2 may output a signal that causes the one or more parameters of the broadband optical signal 24 and/or one or more channels thereof sampled by the OCM 22-2 to be adjusted to be operating within the predetermined tolerance or range.

In an example, the OCM 22-2 may output this signal to the processor or controller 34 that may be programmed, operative and/or configured to, in response to this signal, cause the operation of the appropriate optical transmitter 32 to be adjusted, in the manner described above, whereupon the one or more parameters of the broadband optical signal 24 and/or one or more channels thereof sampled by the OCM 22-2 is/are operating within the predetermined tolerance or range.

Also or alternatively, the OCM 22-2 may output this signal to the optical amplifier 40-1 which may be programmed, operative and/or configured, in response to this signal, for adjusting the one or more parameters of the optical communication signal or channel whereupon the one or more parameters of the broadband optical signal 24 and/or one or more channels thereof output by the optical amplifier 40-1 and sampled by the OCM 22-2 is/are operating within the predetermined tolerance or range.

In another example, an OCM 22-3 may be programmed, operative and/or configured to sample the WLREF broadband optical signal 14 output by the WLREF 2 and to also sample the broadband optical signal 24 output by an optical amplifier 40-2 to the OCM 22-3 via an optical splitter 26-3 after transmission of the broadband optical signal 24 along the transmission optical fiber 16 for amplification by the optical amplifier 40-2. In this example, like the previous examples described above, the OCM 22-3 may be programmed, operative and/or configured for sampling and comparing one or more or each spectral band comprising the WLREF broadband optical signal 14 with the broadband optical signal 24 and/or one or more channels thereof that may have a wavelength channel in the same spectral band. In response to determining from the comparison that the broadband optical signal 24 and/or one or more channels thereof is operating outside of a predetermined tolerance or range, the OCM 22-3 may output a signal that causes the one or more parameters of the broadband optical signal 24 and/or one or more channels thereof to be adjusted to be operating within the predetermined tolerance or range.

In an example, the OCM 22-3 may output this signal to the processor or controller 34 that may be programmed, operative and/or configured to, in response to this signal, cause the operation of the appropriate optical transmitter 32 to be adjusted, in the manner described above, whereupon the one or more parameters of the broadband optical signal 24 and/or one or more channels thereof sampled by the OCM 22-3 is/are operating within the predetermined tolerance or range.

Also or alternatively, the OCM 22-3 may output this signal to the optical amplifier 40-2 that may be programmed, operative and/or configured, in response to this signal, for adjusting the one or more parameters of the optical communication signal or channel whereupon the one or more parameters of the broadband optical signal 24 and/or one or more channels thereof output by the optical amplifier 40-2 and sampled by the OCM 22-3 is/are operating within the predetermined tolerance or range.

In an example, the WDM system 20 shown in FIG. 2 may include along the length of the transmission optical fiber 16 between the optical transmitter block 30 and an optical receiver block 50 more or less than the illustrated two optical amplifiers 40-1 and 40-2, the two OCMs 22-2 and 22-3, and the two splitters 26-2 and 26-3. To this end, the number of each of the optical amplifiers 40, the OCMs 22 and the splitters 26 may be chosen for a particular application and/or length of the transmission optical fiber 16 between the optical transmitter block 30 and the optical receiver block 50 as may be deemed suitable and/or desirable for detecting along the length of the transmission optical fiber 16 that the broadband optical signal 24 and/or one or more channels thereof is operating outside of a predetermined tolerance or range and for causing the one or more parameters of the broadband optical signal 24 and/or one or more channels thereof to be adjusted to be operating within the predetermined tolerance or range. Accordingly, the number of optical amplifiers 40, OCMs 22, and splitters 26 shown in FIG. 2 are not to be construed in a limiting sense.

In an example, the WDM system 20 may include an OCM 22-4 that may be programmed, operative and/or configured to sample the WLREF broadband optical signal 14 output by the WLREF 2 and to also sample the broadband optical signal 24 received by the OCM 22-4 via an optical splitter 26-4 prior to receipt of the broadband optical signal 24 by a wavelength division demultiplexer (WDM DEMUX) 51 of the optical receiver block 50.

In this example, like the previous examples, the OCM 22-4 may be programmed, operative and/or configured for sampling and comparing one or more or each spectral band comprising the WLREF broadband optical signal 14 with the broadband optical signal 24 and/or one or more channels thereof that may have a wavelength channel in the same spectral band. In response to determining from the comparison that the broadband optical signal 24 and/or one or more channels thereof is operating outside of a predetermined tolerance or range, the OCM 22-4 may output a signal that causes the one or more parameters of the broadband optical signal 24 and/or one or more channels thereof to be adjusted to be operating within the predetermined tolerance or range.

In an example, the OCM 22-4 may output this signal to the processor or controller 34 that may be programmed, operative and/or configured to, in response to this signal, cause the operation of the appropriate optical transmitter 32 to be adjusted whereupon the one or more parameters of the broadband optical signal 24 and/or one or more channels thereof is/are operating within the predetermined tolerance or range. For example, assuming the OCM 22-4 determines that the S-band output by transmitter 32-1 is operating outside of a predetermined tolerance or range, the controller 34, in response to the signal of this event or condition output to the controller 34 by the OCM 22-4, may cause the operation of transmitter 32-1 to be adjusted whereupon the one or more parameters of the S-band output by transmitter 32-1 and sampled by the OCM 22-4 is adjusted to be operating within the predetermined tolerance or range.

Herein, each optical splitter 26 may be a passive device or an active device, such as, for example, a Reconfigurable Optical Add-Drop Multiplexer (ROADM).

Finally, the optical receiver block 50 may include the WDM DEMUX 51 that may demultiplex the broadband optical signal 24 into the respective spectral bands and output each demultiplexed spectral band to an appropriate optical receiver 52. In an example, the WDM DEMUX 51 may demultiplex the broadband optical signal 24 into the S-band, the C-band, the L-band and the O-band which the WDM DEMUX 51 may provide to optical receivers 52-1 – 52-4 which may be programmed, operative and/or configured receive the respective S-band, C-band, L-band and O-band spectral bands and to demodulate therefrom data modulated thereon and provide the demodulated data downstream, e.g., to one or more routers.

While the example WDM system 20 shown in FIG. 2 includes a single WLREF 2 (shown in solid line) connected to all of the OCMs 22 of the example WDM system 20 shown in FIG. 2, this is not to be construed in a limiting sense since it is envisioned that each OCM 22 may be coupled to a single, dedicated WLREF 2 (shown in phantom), that two or more OCMs 22 may be coupled to a single WLREF 2, or some combination thereof. For example, OCM 22-1 may be coupled to a one WLREF 2 (shown in phantom), OCM 22-4 may be coupled to another WLREF 2 (shown in phantom), and OCMs 22-2 and 22-3 may be coupled to yet another WLREF 2 (shown in solid line).

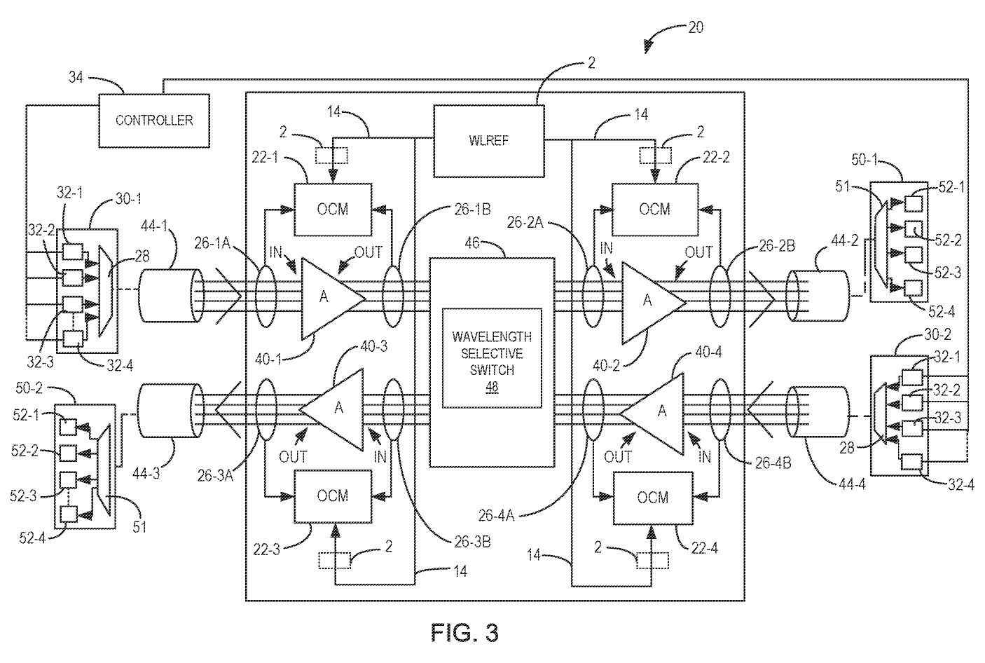

With reference to FIG. 3 and with continuing reference to all previous figures, in some non-limiting embodiments or examples in accordance with the principles of the present disclosure, a single WLREF 2 may be coupled to a number of OCMs 22-1 – 22-4 that may be optically coupled to different sets of transmission optical fibers. However, this is not to be construed in a limiting sense since it is envisioned that each OCM 22 may be coupled to a single, dedicated WLREF 2 (shown in phantom), that two or more OCMs 22 may be coupled to a single WLREF 2, or some combination thereof. For example, OCM 22-1 may be coupled to a one WLREF 2 (shown in phantom), OCM 22-4 may be coupled to another WLREF 2 (shown in phantom), and OCMs 22-2 and 22-3 may be coupled to yet another WLREF 2 (shown in solid line).

In this example, each OCM 22 may be coupled, e.g., via one or more optical splitters 26, to a set of inputs and/or a set of outputs of an optical amplifier 40. In an example, OCM 22-1 may be coupled to a set of inputs and/or a set of outputs of optical amplifier 40-1, OCM 22-2 may be coupled to a set of inputs and/or a set of outputs of optical amplifier 40-2, OCM 22-3 may be coupled to a set of inputs and/or a set of outputs of optical amplifier 40-3, and OCM 22-4 may be coupled to a set of inputs and/or a set of outputs of optical amplifier 40-4.

In this example, the set of inputs and the set of outputs of the optical amplifier 40-1 may be coupled to a set of transmission optical fibers of an input optical fiber bundle 44-1 and to a set of transmission optical fibers that run from outputs of the optical amplifier 40-1 to a set of inputs of an optical switching means 46 comprising a wavelength selective switch (WSS) 48. The set of inputs and the set of outputs of optical amplifier 40-2 may be coupled to a set of transmission optical fibers that run from outputs of the optical switching means 46, comprising the WSS 48, to a set of inputs of the optical amplifier 40-2 and from a set of outputs of optical amplifier 40-2 to a set of transmission optical fibers of an output optical fiber bundle 44-2. The set of inputs and the set of outputs of optical amplifier 40-3 may be coupled to a set of transmission optical fibers that run from a set of outputs of the optical switching means 46, comprising the WSS 48, to a set of inputs of the optical amplifier 40-3 and from a set of outputs of optical amplifier 40-2 to a set of transmission optical fibers of an output optical fiber bundle 44-3. Finally, in this example, the set of inputs and the set of outputs of the optical amplifier 40-4 may be coupled to a set of transmission optical fibers of an input optical fiber bundle 44-4 and to a set of transmission optical fibers that run from a set of outputs of the optical amplifier 40-4 to a set of inputs of the optical switching means 46, comprising the WSS 48. In this disclosure, the terms "transmission optical fiber” and “optical fiber” may be used interchangeably.

In this example, the set of optical fibers running into and out of each optical amplifier 40 may each comprise one or more individual optical fibers, each of which may carry one or more optical communication signals or broadband optical signals. In an example, optical amplifiers 40-1 and 40-4 may amplify the broadband optical signals propagating to the set of inputs of the optical amplifiers 40-1 and 40-4 and may provide, via the set of outputs of the optical amplifiers 40-1 and 40-4, amplified broadband optical signals to the optical switching means 46 comprising the WSS 48. In a manner known in the art, the WSS 48 may be programmed, operative and/or configured to selectively route the set of broadband optical signals received by the optical switching means 46 from input optical fiber bundles 44-1 and 44-4 via amplifiers 40-1 and 40-4 to desired optical fibers in at least one of the sets of output optical fiber bundles 44-2 and 44-3. The operation of the WSS 48 to route broadband optical signal from one or more optical fibers of the set of input optical fiber bundles 44-1 and 44-4 to one or more optical fibers of the set of output optical fiber bundles 44-2 and 44-3 is well known in the art and will not be described further herein for the purpose of simplicity. In a manner know in the art, each optical amplifier 40 amplifies the set of optical signals input thereto and outputs the set of amplified optical signals.

In an example, the WLREF 2 shown in solid line may be programmed, operative and/or configured to output to each OCM 22 connected to the WLREF 2 the WLREF broadband optical signal 14. Also or alternatively, each WLREF 2 shown in phantom lines may be programmed, operative and/or configured to output its WLREF broadband optical signal 14 to the OCM 22 connected thereto. Each OCM 22 may be programmed, operative, and/or configured for sampling and comparing one or more spectral bands comprising the WLREF broadband optical signal 14 with one or more optical communication signals and/or one or more channels thereof that may have a wavelength channel in the same spectral band as the one or more spectral band comprising the WLREF broadband optical signal 14.

In an example, the OCM 22-1 may be programmed, operative and/or configured for sampling and comparing one or more or each spectral band comprising the WLREF broadband optical signal 14 with one or more broadband optical signals and/or one or more channels thereof sampled, via one or more optical splitters 26-1A and 26-1B, from one or more optical fibers input into or output from optical amplifier 40-1 that may have a wavelength channel in the same spectral band. For example, the OCM 22-1 may sample broadband optical signals in the S-band and C-band propagating on one or more transmission optical fibers input into or output from optical amplifier 40-1 and may compare the S-band and C-band optical signals comprising the WLREF broadband optical signal 14 output by the WLREF 2 to the OCM 22-1 with the sampled S-band and C-band broadband optical signals. In this example, the sampled S-band and C-band broadband optical signals may be co-propagating on a single transmission optical fiber or may be propagating on separate transmission optical fibers.

In response to determining from this comparison that the one or more broadband optical signals and/or one or more channels thereof is/are operating outside of a predetermined tolerance or range, the OCM 22-1 may output a signal that causes the one or more parameters of each of the one or more broadband optical signals and/or one or more channels thereof sampled by the OCM 22-1 to be adjusted to be operating within the predetermined tolerance or range.

In an example, this signal output by the OCM 22-1 may be provided to the WSS 48 which may be programmed, operative and/or configured to adjust the one or more parameters of each of the one or more broadband optical signals and/or one or more channels thereof to be operating within the predetermined tolerance or range. In another example, the signal output by the OCM 22-1 may be provided to optical amplifier 40-1 which may be programmed, operative and/or configured to adjust the one or more parameters of each of the one or more broadband optical signals and/or one or more channels thereof to be operating within the predetermined tolerance or range. In yet another example, the signal output by the OCM 22-1 may be provided to a controller 34 which may be programmed, operative and/or configured to cause the operation of one or more optical transmitters 32 of an optical transmitter block 30-1 to be adjusted whereupon the one or more parameters of each of the one or more broadband optical signals and/or one or more channels thereof is/are operating within the predetermined tolerance or range. In FIG. 3, the line(s) to communicate the signal from the OCM 22-1 to the WSS 48, the optical amplifier 40-1, and/or the controller 34 is/are omitted for simplicity.

In an example, the predetermined tolerance or range of the one or more broadband optical signals and/or one or more channels thereof and the one or more parameters to be adjusted may include an optical frequency, an optical power and/or a spectral power tilt.

FIG. 3 includes optical transmitter blocks 30-1 and 30-2, each including optical transmitters 32-1 – 32-4 and an optional WDM MUX 28 (representative of one or more optional WDM MUX’s) for providing optical signals to input optical fiber bundles 44-1 and 44-4. In the example shown in FIG. 3, some or all of the optical transmitters 32 may each be coupled directly to individual optical fibers of the input optical fiber bundles 44-1 and 44-4. Also or alternatively, each optional WDM MUX 28 may be used to combine two or more broadband optical signals and/or two or more channels thereof output by two or more optical transmitters 32 onto a single optical fiber of the corresponding input optical fiber bundle 44.

FIG. 3 also includes optical receiver blocks 50-2 and 50-3, each including optical receivers 52-1 – 52-4 and an optional WDM DEMUX 51 (representative of one or more optional WDM DEMUX’s) for receiving optical signals from output optical fiber bundles 44-2 and 44-3. In the example shown in FIG. 3, some or all of the optical receivers 52 may be coupled directly to individual optical fibers of the output optical fiber bundles 44-2 and 44-3. Also or alternatively, each optional WDM DEMUX 51 may be used to separate and provided to two or more optical receivers 52 two or more broadband optical signals and/or two or more channels thereof received by the optional WDM DEMUX 51 on a single optical fiber of the corresponding optical fiber bundle 44.

In another example, the OCM 22-4 may be programmed, operative and/or configured for sampling and comparing one or more or each spectral band comprising the WLREF broadband optical signal 14 with one or more broadband optical signals and/or one or more channels thereof sampled, via one or more optical splitters 26-4A and 26-4B, from one or more optical fibers input into or output from optical amplifier 40-4 that may have a wavelength channel in the same spectral band. For example, the OCM 22-4 may sample broadband optical signals in the S-band and C-band propagating on one or more transmission optical fibers input into or output from optical amplifier 40-4 and may compare the S-band and C-band optical signals comprising the WLREF broadband optical signal 14 output by the WLREF 2 to the OCM 22-4 with the sampled S-band and C-band broadband optical signals. In this example, the sampled S-band and C-band broadband optical signals may be co-propagating on a single transmission optical fiber or may be propagating on separate transmission optical fibers.

In response to determining from this comparison that the one or more broadband optical signals and/or one or more channels thereof is/are operating outside of a predetermined tolerance or range, the OCM 22-4 may output a signal that causes the one or more parameters of each of the one or more broadband optical signals and/or one or more channels thereof sampled by the OCM 22-4 to be adjusted to be operating within the predetermined tolerance or range.

In an example, the signal output by the OCM 22-4 may be provided to the WSS 48 which may be programmed, operative and/or configured to adjust the one or more parameters of each of the one or more broadband optical signals sampled by the OCM 22-4 and/or one or more channels thereof to be operating within the predetermined tolerance or range. In another example, the signal output by the OCM 22-4 may be provided to optical amplifier 40-4 which may be programmed, operative and/or configured to adjust the one or more parameters of each of the one or more broadband optical signals and/or one or more channels thereof sampled by the OCM 22-4 to be operating within the predetermined tolerance or range. In yet another example, the signal output by the OCM 22-4 may be provided to the controller 34 which may be programmed, operative and/or configured to cause the operation of one or more optical transmitters 32 of an optical transmitter block 30-2 to be adjusted whereupon the one or more parameters of each of the one or more broadband optical signals and/or one or more channels thereof sampled by the OCM 22-4 is/are operating within the predetermined tolerance or range. InFIG. 3, the line(s) to communicate the signal from the OCM 22-4 to the WSS 48, the optical amplifier 40-4, and/or the controller 34 is/are omitted for simplicity.

In another example, the OCM 22-2 may be programmed, operative and/or configured for sampling and comparing one or more or each spectral band comprising the WLREF broadband optical signal 14 with one or more broadband optical signals and/or one or more channels thereof sampled, via one or more optical splitters 26-2A and 26-2B, from one or more optical fibers input into or output from optical amplifier 40-2 that may have a wavelength channel in the same spectral band. For example, the OCM 22-2 may sample broadband optical signals in the S-band and C-band propagating on one or more transmission optical fibers input into or output from optical amplifier 40-2 and may compare the S-band and C-band optical signals output by the WLREF 2 with the sampled S-band and C-band broadband optical signals. In this example, the sampled S-band and C-band broadband optical signals may be co-propagating on a single transmission optical fiber or may be propagating on separate transmission optical fibers.

In response to determining from this comparison that the one or more broadband optical signals and/or one or more channels thereof is/are operating outside of a predetermined tolerance or range, the OCM 22-2 may output a signal that causes the one or more parameters of each of the one or more broadband optical signals and/or one or more channels thereof sampled by the OCM 22-2 to be adjusted to be operating within the predetermined tolerance or range.

In an example, the signal output by the OCM 22-2 may be provided to the WSS 48 which may be programmed, operative and/or configured to adjust the one or more parameters of each of the one or more broadband optical signals and/or one or more channels thereof sampled by the OCM 22-2 to be operating within the predetermined tolerance or range. In another example, the signal output by the OCM 22-2 may be provided to optical amplifier 40-2 which may be programmed, operative and/or configured to adjust the one or more parameters of each of the one or more broadband optical signals and/or one or more channels thereof sampled by the OCM 22-2 to be operating within the predetermined tolerance or range. In yet another example, the signal output by the OCM 22-2 may be provided to the controller 34 which may be programmed, operative and/or configured to cause the operation of one or more optical transmitters 32 of one or more of the optical transmitter blocks 30-1 and 30-2 to be adjusted whereupon the one or more parameters of the broadband optical signal and/or one or more channels thereof sampled by the OCM 22-2 is/are operating within the predetermined tolerance or range. In FIG. 3, the line(s) to communicate the signal from the OCM 22-2 to the WSS 48, the optical amplifier 40-2, and/or the controller 34 is/are omitted for simplicity.

In another example, the OCM 22-3 may be programmed, operative and/or configured for sampling and comparing one or more or each spectral band comprising the WLREF broadband optical signal 14 with one or more broadband optical signals and/or one or more channels thereof sampled, via one or more optical splitters 26-3A and 26-3B, from one or more optical fibers input into or output from optical amplifier 40-3 that may have a wavelength channel in the same spectral band. For example, the OCM 22-3 may sample broadband optical signals in the S-band and C-band propagating on one or more transmission optical fibers input into or output from optical amplifier 40-3 and may compare the S-band and C-band optical signals output by the WLREF 2 with the sampled S-band and C-band broadband optical signals. In this example, the sampled S-band and C-band broadband optical signals may be co-propagating on a single transmission optical fiber or may be propagating on separate transmission optical fibers.

In response to determining from this comparison that the one or more broadband optical signals and/or one or more channels thereof is/are operating outside of a predetermined tolerance or range, the OCM 22-3 may output a signal that causes the one or more parameters of each of the one or more broadband optical signals and/or one or more channels thereof sampled by the OCM 22-3 to be adjusted to be operating within the predetermined tolerance or range.

In an example, the signal output by the OCM 22-3 may be provided to the WSS 48 which may be programmed, operative and/or configured to adjust the one or more parameters of each of the one or more broadband optical signals and/or one or more channels thereof sampled by the OCM 22-3 to be operating within the predetermined tolerance or range. In another example, the signal output by the OCM 22-3 may be provided to optical amplifier 40-3 which may be programmed, operative and/or configured to adjust the one or more parameters of each of the one or more broadband optical signals and/or one or more channels thereof sampled by the OCM 22-3 to be operating within the predetermined tolerance or range. In yet another example, the signal output by the OCM 22-3 may be provided to the controller 34 which may be programmed, operative and/or configured to cause the operation of one or more optical transmitters 32 of one or more of the optical transmitter blocks 30-1 and 30-2 to be adjusted whereupon the one or more parameters of the broadband optical signal and/or one or more channels thereof sampled by the OCM 22-3 are operating within the predetermined tolerance or range. In FIG. 3, the line(s) to communicate the signal from the OCM 22-3 to the WSS 48, the optical amplifier 40-3, and/or the controller 34 is/are omitted for simplicity.

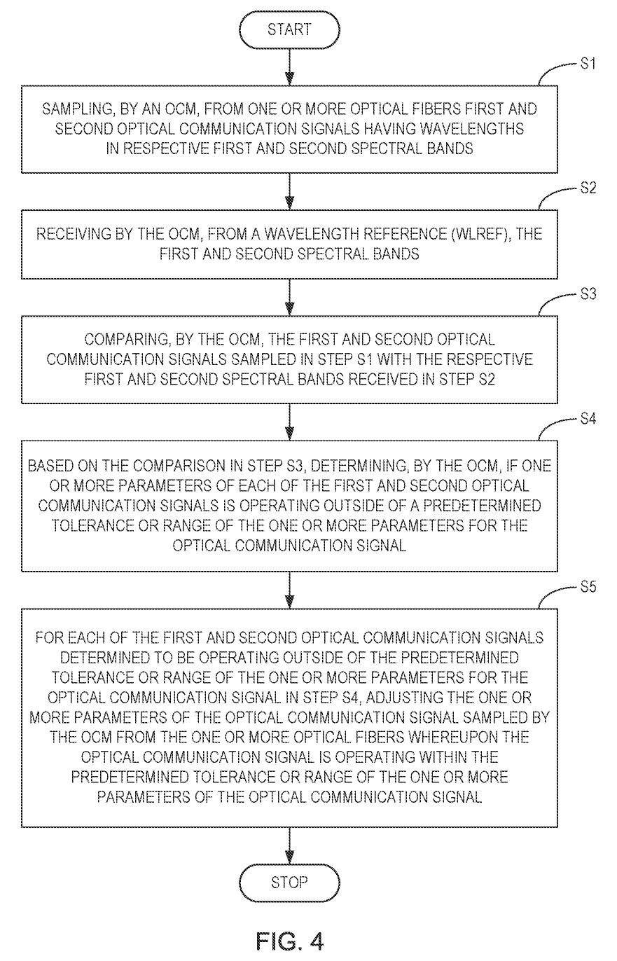

With reference to FIG. 4 and with continuing reference to all previous figures, a method in accordance with the principles of the present disclosure will now be described with reference to a wavelength division multiplexing (WDM) system 20 that includes first and second optical transmitters, e.g., optical transmitters 32-1 and 32-2, outputting into one or more optical fibers first and second optical communication signals (e.g., the S-band and the C-band spectral bands), first and second optical receivers, e.g., optical receivers 52-1 and 52-2, receiving from one or more optical fiber the first and second optical communication signals, and at least one optical channel monitor (OCM) 22 optically coupled to the optical fiber.

The method may comprise step S1: sampling, by the OCM, from the one or more optical fibers first and second optical communication signals having wavelengths in respective first and second spectral bands. The method may further comprise step S2: receiving by the OCM, from a wavelength reference (WLREF), the first and second spectral bands; and step S3: comparing, by the OCM, the first and second optical communication signals sampled in step S1 with the respective first and second spectral bands received in step S2. The method may further comprise step S4: based on the comparison in step S3, determining, e.g., by the OCM, if one or more parameters of each of the first and second optical communication signals is operating outside of a predetermined tolerance or range of the one or more parameters for the optical communication signal; and step S5: for each of the first and second optical communication signals determined to be operating outside of the predetermined tolerance or range of the one or more parameters for the optical communication signal in step S4, adjusting the one or more parameters of the optical communication signal sampled by the OCM from the one or more optical fibers whereupon the optical communication signal is operating within the predetermined tolerance or range of the one or more parameters of the optical communication signal.

In one example, the adjusting in step S5 may be performed via an optical amplifier that is optically coupled to the one or more optical fibers for amplifying the first and second optical communication signals. The optical amplifier may be programmed, operative and/or configured for adjusting the one or more parameters based on the determination by the OCM 22 in step S4.

In another example, the adjusting in step S5 may be performed via a WSS 48 that is optically coupled in a signal path of the first and second optical communication signals sampled by the OCM 22. In this example, the WSS 48 may be programmed, operative and/or configured for adjusting the one or more parameters based on the determination by the OCM 22 in step S4.

In yet another example, the adjusting in step S5 may be performed via a controller that is coupled between the OCM 22 and the first and second optical transmitters. The controller may be programmed, operative and/or configured for causing the one or more parameters to be adjusted based on the determination by the OCM in step S4.

In an example, the first and second spectral bands may include two of the following spectral bands: a C-band, an L-band, an S-band, an O-band, an E-band, and a U-band.

In an example, the one or more parameters of the optical communication signal may include an optical frequency, e.g., an optical frequency offset from a desired optical frequency, an optical power, e.g., an optical power offset from a desired optical power, a spectral power tilt, e.g., a spectral power tilt offset from a desired spectral power tilt, or some combination of the optical frequency, the optical power and/or the spectral power tilt of the one or more of the channels and/or spectral bands of the optical communication signal sampled by the OCM from the optical fiber.

As can be seen, disclosed herein is a wavelength division multiplexing (WDM) system 20 that may comprise, at least, first and second optical transmitters 32-1 and 32-1 outputting into an input end of one or more optical fibers first and second optical communication signals having wavelengths in respective first and second spectral bands, for example, without limitation, the S-band and the C-band. First and second optical receivers 52-1 and 52-2 may receive the first and second optical communication signals. At least one optical channel monitor (OCM) 22 may be optically coupled to the one or more optical fibers. The OCM 22 may be programmed, operative and/or configured for sampling from the one or more optical fibers the first and second optical communication signals. A wavelength reference (WLREF) 2 may be optically coupled to the OCM 22 and may be programmed, operative and/or configured for outputting to the OCM the first and second spectral bands.

The OCM 22 may be programmed, operative and/or configured for comparing the first and second optical communication signals sampled by the OCM 22 with the respective first and second spectral bands. The OCM 22 may also be programmed, operative and/or configured for determining from the comparison if one or more parameters of each of the first and second optical communication signals is operating outside of a predetermined tolerance or range for the one or more parameters of the optical communication signal. In an example, these one or more parameters may include an optical frequency, e.g., an optical frequency offset from a desired optical frequency, an optical power, e.g., an optical power offset from a desired optical power, a spectral power tilt, e.g., a spectral power tilt offset from a desired spectral power tilt, or some combination of the optical frequency, the optical power and/or the spectral power tilt of each of one or more of channels or spectral bands of the optical communication signal.

For each of the first and second optical communication signals determined by the OCM to be operating outside of the predetermined tolerance or range of the one or more parameters of the optical communication signal, the one or more parameters of the optical communication signal sampled by the OCM may be adjusted whereupon the optical communication signal is operating within the predetermined tolerance or range of the one or more parameters of the optical communication signal.

In an example, the adjusting of the one or more parameters of the optical communication signal sampled by the OCM 22 may be performed by an optical amplifier 40 that is optically coupled to the optical fiber carrying the optical communication signal for amplifying the optical communication signal. In an example, the optical amplifier 40 may be programmed, operative and/or configured for adjusting the one or more parameters based on the determination by the OCM 22.

In another example, the adjusting of the one or more parameters of the optical communication signal sampled by the OCM 22 may be performed by a WSS 48 that is coupled in a signal path of the optical communication signal sampled by the OCM 22. In this example, the WSS 48 may be programmed, operative and/or configured for adjusting the one or more parameters based on the determination by the OCM 22.

In another example, the adjusting of the one or more parameters of the optical communication signal sampled by the OCM 22 may be performed by a controller 34 that is coupled between the OCM 22 and the first and second optical transmitters. In this example, the controller 34 may be programmed, operative and/or configured for causing the one or more parameters to be adjusted based on the determination by the OCM 22.

While the examples shown in FIGS. 2 and 3 include a single controller 34 connected to all of the OCMs 22, this is not to be construed in a limiting sense since it is envisioned that multiple controllers (not specifically shown) may be provided, wherein each said controller may be coupled to one or more OCMs 22 and each said controller may be programmed, operative and/or configured for causing the one or more parameters to be adjusted based on the determination by the OCM 22 coupled to the controller.

In an example, the WDM system 20 may include a third optical transmitter 32-3 outputting into the input end of the one or more optical fibers a third optical communication signal having a wavelength in a third spectral band and a third optical receiver 52-3 may receive the third optical communication signal. The WLREF 2 may be optically coupled to the OCM 22 and may be programmed, operative and/or configured for outputting to the OCM 22 the third spectral band. The OCM 22 may be programmed, operative and/or configured for comparing the third optical communication signal sampled by the OCM 22 from the one or more optical fibers with the third spectral band. The OCM 22 may be programmed, operative and/or configured for determining from the comparison of the third optical communication signal with the third spectral band if one or more parameters of the third optical communication signal is operating outside of a predetermined tolerance or range of the third optical communication signal.

In response to determining that the third optical communication signal is operating outside of the predetermined tolerance or range of the one or more parameters, e.g., an optical frequency, such as an optical frequency offset from a desired optical frequency, an optical power, such as an optical power offset from a desired optical power, a spectral power tilt, such as a spectral power tilt offset from a desired spectral power tilt, or some combination of the optical frequency, the optical power and/or the spectral power tilt, of the third optical communication signal, the optical amplifier 40, the WSS 48, or the controller 34 may adjust or cause to be adjusted the one or more parameters of the third optical communication signal sampled by the OCM 22 from the one or more optical fibers whereupon the third optical communication signal is operating within the predetermined tolerance or range of the one or more parameters of the third optical communication signal.

In an example, the WDM system 20 may include a fourth optical transmitter 32-4 outputting into the input end of the one or more optical fibers a fourth optical communication signal having a wavelength in a fourth spectral band and a fourth optical receiver 52-4 receiving the fourth optical communication signal. The WLREF 2 may be optically coupled to the OCM 22 and programmed, operative and/or configured for outputting to the OCM 22 the fourth spectral band The OCM 22 may be programmed, operative and/or configured for comparing the fourth optical communication signal sampled by the OCM 22 from the one or more optical fibers with the fourth spectral band. The OCM 22 may be programmed, operative and/or configured for determining from the comparison of the fourth optical communication signal with the fourth spectral band if one or more parameters of the fourth optical communication signal is operating outside of a predetermined tolerance or range of the fourth optical communication signal.

In response to determining that the fourth optical communication signal is operating outside of the predetermined tolerance or range of the one or more parameters, e.g., an optical frequency, such as an optical frequency offset from a desired optical frequency, an optical power, such as an optical power offset from a desired optical power, a spectral power tilt, such as a spectral power tilt offset from a desired spectral power tilt, or some combination of the optical frequency, the optical power and/or the spectral power tilt, of the fourth optical communication signal, the optical amplifier 40, the WSS 48, or the controller 34 may adjust or cause to be adjusted the one or more parameters of the fourth optical communication signal sampled by the OCM 22 from the one or more optical fibers whereupon the fourth optical communication signal is operating within the predetermined tolerance or range of the one or more parameters of the fourth optical communication signal.

In an example, the first and second spectral bands may include two of the following spectral bands: a C-band, an L-band, an S-band, an O-band, an E-band and a U-band.

In an example, the at least one OCM 22 may include two or more OCMs 22, wherein each OCM 22 may be optically coupled to a different section of the optical fiber or to different optical fibers and is programmed, operative and/or configured for sampling the first and second optical communication signals. The WLREF 2 may be optically coupled to each OCM 22 and may be programmed, operative and/or configured for outputting to each OCM 22 the first and second spectral bands.

Each OCM 22 may be programmed, operative and/or configured for comparing the first and second optical communication signals sampled by the OCM with the respective first and second spectral bands. Each OCM 22 may also be programmed, operative and/or configured for determining from the comparison by the OCM 22 if one or more parameters of each of the first and second optical communication signals is operating outside of the predetermined tolerance or range of the one or more parameters of the optical communication signal.

For each of the first and second optical communication signals determined by one of the OCMs 22 to be operating outside of the predetermined tolerance or range of the one or more parameters of the optical communication signal, the one or more parameters of the optical communication signal sampled by the OCM 22 from the one or more optical fibers may be adjusted, e.g., by an optical amplifier 40, a WSS 48, or a controller 34, whereupon the optical communication signal output by the corresponding optical transmitter is operating within the predetermined tolerance or range of the one or more parameters of the optical communication signal.

Other non-limiting examples or aspects of this disclosure are set forth in the following illustrative and exemplary numbered clauses:

Clause 1: A wavelength reference (WLREF) may comprise a plurality of individual spectral band sources, wherein each spectral band source may be programmed, operative and/or configured for outputting a different spectral band than each other spectral band source. One or more combiners may be programmed, operative and/or configured for combining the different spectral band into a broadband optical signal and for outputting the broadband optical signal.

Clause 2: The WLREF of clause 1, may further include an optical filter programmed, operative and/or configured for filtering the broadband optical signal being output.

Clause 3. A wavelength division multiplexing (WDM) system may comprise the WLREF of clause 1 outputting the broadband optical signal to an optical channel monitor (OCM) that may be programmed, operative and/or configured for sampling and comparing each spectral band comprising the broadband optical signal with an optical communication signal and/or channel having a wavelength in the spectral band and, in response to determining from the comparison that the optical communication signal or channel may be operating outside of a predetermined tolerance or range, the OCM may output a signal that causes the one or more parameters of the optical communication signal or channel to be adjusted to be operating within the predetermined tolerance or range.

Clause 4. The WDM system of clause 3, wherein the signal may be output to: an optical amplifier that may be programmed, operative and/or configured for amplifying the optical communication signal or channel and which may be responsive to the signal output by the OCM for adjusting the one or more parameters of the optical communication signal or channel; or a wavelength selective switch (WSS) that may be responsive to the signal output by the OCM for adjusting the one or more parameters of the optical communication signal or channel, or a controller that may be responsive to the signal output by the OCM for causing an optical source of the optical communication signal or channel to adjust the one or more parameters of the optical communication signal or channel.

Clause 5: In a wavelength division multiplexing (WDM) system that may include first and second optical communication signals co-propagating on a single optical fiber or propagating separately on separate optical fibers, and at least one optical channel monitor (OCM) programmed, operative and/or configured to sample the first and second optical communication signals, a method comprising: (a) sampling, by the OCM, from the one or more optical fibers the first and second optical communication signals having wavelengths in respective first and second spectral bands; (b) receiving by the OCM, from a wavelength reference (WLREF), the first and second spectral bands; (c) comparing, by the OCM, the first and second optical communication signals sampled in step (a) with the respective first and second spectral bands received in step (b); (d) based on the comparison in step (c), determining, by the OCM, if one or more parameters of each of the first and second optical communication signals is operating outside of a predetermined tolerance or range of the one or more parameters for the optical communication signal; and (e) for each of the first and second optical communication signals determined to be operating outside of the predetermined tolerance or range of the one or more parameters for the optical communication signal in step (d), adjusting the one or more parameters of the optical communication signal sampled by the OCM whereupon the optical communication signal is operating within the predetermined tolerance or range of the one or more parameters of the optical communication signal.

Clause 6. The method of clause 5, wherein the adjusting in step (e) may be performed via: an optical amplifier that may be optically coupled to the one or more optical fibers for amplifying the first and second optical communication signals, wherein the optical amplifier may be programmed, operative and/or configured for adjusting the one or more parameters based on the determination by the OCM in step (d); or a wavelength selective switch (WSS) through which the first and second optical communication signals propagate, wherein the WSS may be programmed, operative and/or configured for adjusting the one or more parameters based on the determination by the OCM in step (d); or a controller that may be coupled to the OCM, wherein the controller may be programmed, operative and/or configured for causing the one or more parameters to be adjusted based on the determination by the OCM in step (d).

Clause 7. The method of clause 5 or 6, wherein the first and second spectral bands may include two of the following spectral bands: a C-band, an L-band, an S-band, an O-band, an E-band and a U-band.

Clause 8: The method of any one of clauses 5-7, wherein the one or more parameters may include an optical frequency, an optical power, a spectral power tilt, or some combination of the optical frequency, the optical power and/or the spectral power tilt of the optical communication signal.

Clause 9: The method of any one of clauses 5-8, wherein the first and second optical communication signals may be output into the input end of the one or more optical fibers via a WDM multiplexer.

Clause 10: The method of any one of clauses 5-9, wherein the first and second optical communication signals may be output from the output end of the one or more optical fibers to the first and second optical receivers via a WDM de-multiplexer.

Clause 11: The method of any one of clauses 5-10, wherein the at least one OCM may be coupled to the one or more optical fiber via an optical splitter.

Clause 12: A wavelength division multiplexing (WDM) system may comprise: first and second optical transmitters outputting into an input end of one or more optical fibers first and second optical communication signals having wavelengths in respective first and second spectral bands. First and second optical receivers may receive the first and second optical communication signals. At least one optical channel monitor (OCM) may be optically coupled to the one or more optical fibers, wherein the OCM may be programmed, operative and/or configured for sampling from the one or more optical fibers the first and second optical communication signals. A wavelength reference (WLREF) may be optically coupled to the OCM and may be programmed, operative and/or configured for outputting to the OCM the first and second spectral bands. The OCM may be programmed, operative and/or configured for comparing the first and second optical communication signals sampled by the OCM with the respective first and second spectral bands; and the OCM may be programmed, operative and/or configured for determining from the comparison if one or more parameters of each of the first and second optical communication signals is operating outside of a predetermined tolerance or range of the one or more parameters of the optical communication signal. For each of the first and second optical communication signals determined by the OCM to be operating outside of the predetermined tolerance or range of the one or more parameters of the optical communication signal, the one or more parameters of the optical communication signal sampled by the OCM may be adjusted whereupon the optical communication signal is operating within the predetermined tolerance or range of the one or more parameters of the optical communication signal.

Clause 13: The system of clause 12, wherein the adjusting of the one or more parameters of the optical communication signal sampled by the OCM may be performed by: an optical amplifier that may be optically coupled to the one or more optical fibers for amplifying the first and second optical communication signals, wherein the optical amplifier may be programmed, operative and/or configured for adjusting the one or more parameters based on the determination by the OCM; or a wavelength selective switch (WSS) through which the first and second optical communication signals propagate, wherein the WSS is programmed, operative and/or configured for adjusting the one or more parameters based on the determination by the OCM; or a controller that may be coupled to the OCM, wherein the controller may be programmed, operative and/or configured for causing the one or more parameters to be adjusted based on the determination by the OCM.

Clause 14: The WDM system of clause 12 or 13, may further include: a third optical transmitter that may output into the input end of the one or more optical fibers a third optical communication signal having a wavelength in a third spectral band. A third optical receiver may receive the third optical communication signal. The WLREF may be optically coupled to the OCM and programmed, operative and/or configured for outputting to the OCM the third spectral band. The OCM may be programmed, operative and/or configured for comparing the third optical communication signal sampled by the OCM with the third spectral band. The OCM may be programmed, operative and/or configured for determining from the comparison of the third optical communication signal with the third spectral band if one or more parameters of the third optical communication signal is operating outside of a predetermined tolerance or range of the third optical communication signal. In response to determining that the third optical communication signal is operating outside of the predetermined tolerance or range of the one or more parameters of the third optical communication signal, the optical amplifier, the WSS, or the controller may adjust the one or more parameters of the third optical communication signal sampled by the OCM whereupon the third optical communication signal is operating within the predetermined tolerance or range of the one or more parameters of the third optical communication signal.

Clause 15: The system of any one of clauses 12-14, further including: a fourth optical transmitter may output into the input end of the one or more optical fibers a fourth optical communication signal having a wavelength in a fourth spectral band. A fourth optical receiver may receive the fourth optical communication signal. The WLREF may be optically coupled to the OCM and programmed, operative and/or configured for outputting to the OCM the fourth spectral band. The OCM may be programmed, operative and/or configured for comparing the fourth optical communication signal sampled by the OCM with the fourth spectral band; and the OCM may be programmed, operative and/or configured for determining from the comparison of the fourth optical communication signal with the fourth spectral band if one or more parameters of the fourth optical communication signal is operating outside of a predetermined tolerance or range of the fourth optical communication signal. In response to determining that the fourth optical communication signal is operating outside of the predetermined tolerance or range of the one or more parameters of the fourth optical communication signal, the optical amplifier, the WSS or the controller may adjust the one or more parameters of the fourth optical communication signal sampled by the OCM whereupon the fourth optical communication signal is operating within the predetermined tolerance or range of the one or more parameters of the fourth optical communication signal.

Clause 16: The system of any one of clauses 12-15, wherein the first and second spectral bands may include two of the following spectral bands: a C-band, an L-band, an S-band, an O-band, an E-band and a U-band.

Clause 17: The system of any one of clauses 12-16, wherein the one or more parameters may include an optical frequency, an optical power, a spectral power tilt, or some combination of the optical frequency, the optical power and/or the spectral power tilt of the optical communication signal.

Clause 18: The system of any one of clauses 12-17, wherein the first and second optical communication signals may be output into the input end of the one or more optical fibers via a WDM multiplexer.

Clause 19: The system of any one of clauses 12-18, wherein the first and second optical communication signals may output from the output end of the one or more optical fibers to the first and second optical receivers via a WDM de-multiplexer.

Clause 20: The system of any one of clauses 12-19, wherein the OCM may be coupled to the one or more optical fibers via an optical splitter.

Clause 21: The system of any one of clauses 12-20, wherein: the at least one OCM may include two or more OCMs, wherein each OCM may be optically coupled to a different section of the one or more optical fibers and may be programmed, operative and/or configured for sampling from the one or more optical fibers the first and second optical communication signals. The WLREF may be optically coupled to each OCM and may be programmed, operative and/or configured for outputting to each OCM the first and second spectral bands. Each OCM may be programmed, operative and/or configured for comparing the first and second optical communication signals sampled by the OCM with the respective first and second spectral bands. Each OCM may be programmed, operative and/or configured for determining from the comparison by the OCM if one or more parameters of each of the first and second optical communication signals is operating outside of the predetermined tolerance or range of the one or more parameters of the optical communication signal. For each of the first and second optical communication signals determined by the OCM to be operating outside of the predetermined tolerance or range of the one or more parameters of the optical communication signal, the one or more parameters of the optical communication signal sampled by the OCM may be adjusted whereupon the optical communication signal output by the corresponding optical transmitter is operating within the predetermined tolerance or range of the one or more parameters of the optical communication signal.

Clause 22: A wavelength division multiplexing (WDM) system may comprise: a wavelength selective switch (WSS) optically coupled between first and second optical fiber bundles; a first optical channel monitor (OCM1) programmed, operative and/or configured for sampling a first set of optical communication signals having a first set of wavelengths in a first set of spectral bands propagating on a first set of optical fibers of the first optical fiber bundle; a second optical channel monitor (OCM2) programmed, operative and/or configured for sampling a second set of optical communication signals having a second set of wavelengths in a second set of spectral bands propagating on a second set of optical fibers of the second optical fiber bundle; and a wavelength reference (WLREF) optically coupled to the OCM1 and the OCM 2, the WLREF programmed, operative and/or configured for outputting to the OCM1 and the OCM2 the first and second sets of spectral bands. The OCM1 may be programmed, operative and/or configured for comparing the first set of optical communication signals with the first set of spectral bands and for determining from the comparison if one or more parameters of the first set of optical communication signals is operating outside of a predetermined tolerance or range of a set of parameters of the first set of optical communication signals wherein, in response to the OCM1 determining that the first set of optical communication signals is operating outside of the predetermined tolerance or range of the set of parameters of the first set of optical communication signals, the set of parameters of the first set of optical communication signals may be adjusted whereupon the first set of optical communication signals is operating within the predetermined tolerance or range of the set of parameters of the first set of optical communication signals. The OCM2 may be programmed, operative and/or configured for comparing the second set of optical communication signals with the second set of spectral bands and for determining from the comparison if one or more parameters of the second set of optical communication signals is operating outside of a predetermined tolerance or range of a set of parameters of the second set of optical communication signals wherein, in response to the OCM2 determining that the second set of optical communication signals is operating outside of the predetermined tolerance or range of the set of parameters of the second set of optical communication signals, the set of parameters of the second set of optical communication signals may be adjusted whereupon the second set of optical communication signals is operating within the predetermined tolerance or range of the set of parameters of the second set of optical communication signals.

Clause 23: The system of clause 22, wherein at least one of the following: the first and second sets of wavelengths may be the same; and the first and second sets of spectral bands may be the same.

Clause 24: The system of clause 22 or 23, wherein the adjusting of the one or more parameters of each optical communication signal may be performed by: the WSS; or an optical amplifier that is programmed, operative and/or configured to amplify the optical communication signal; or a controller that is coupled to an optical transmitter that outputs the optical communication signal, wherein the controller is programmed, operative and/or configured to cause the optical transmitter to adjust the one or more parameters of the optical signal.

Clause 25, The system of any one of clauses 22-24, wherein, at least one of the following: each set of optical communication signals includes at least one optical communication signal; each set of wavelengths includes at least one wavelength; each set of spectral bands includes at least one spectral band; each set of optical fibers includes at least one optical fiber; and the set of parameters of each set of optical communication signals includes at least one parameter.

Although this disclosure has been described in detail for the purpose of illustration based on what is currently considered to be the most practical and preferred embodiments, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. A wavelength reference (WLREF) comprising:
a plurality of individual spectral band sources, each spectral band source programmed, operative and/or configured for outputting a different spectral band than each other spectral band source; and
one or more combiners programmed, operative and/or configured for combining the different spectral band into a broadband optical signal and for outputting the broadband optical signal.

2. The WLREF of claim 1, further including an optical filter programmed, operative and/or configured for filtering the broadband optical signal being output.

3. A wavelength division multiplexing (WDM) system comprising the WLREF of claim 1, outputting the broadband optical signal to an optical channel monitor (OCM) that is programmed, operative and/or configured for sampling and comparing each spectral band comprising the broadband optical signal with an optical communication signal or channel having a wavelength in the spectral band and, in response to determining from the comparison that the optical communication signal or channel is operating outside of a predetermined tolerance or range, the OCM outputting a signal that causes the one or more parameters of the optical communication signal or channel to be adjusted to be operating within the predetermined tolerance or range.

4. The WDM system of claim 3, wherein the signal is output to:
an optical amplifier that is programmed, operative and/or configured for amplifying the optical communication signal or channel and is responsive to the signal output by the OCM for adjusting the one or more parameters of the optical communication signal or channel; or
a wavelength selective switch (WSS) that is responsive to the signal output by the OCM for adjusting the one or more parameters of the optical communication signal or channel; or a controller that is responsive to the signal output by the OCM for causing an optical source of the optical communication signal or channel to adjust the one or more parameters of the optical communication signal or channel.

5. In a wavelength division multiplexing (WDM) system that includes
first and second optical communication signals co-propagating on a single optical fiber or propagating separately on separate optical fibers, and
at least one optical channel monitor (OCM) programmed, operative and/or configured to sample the first and second optical communication signals, a method comprising:
(a) sampling, by the OCM, from the one or more optical fibers the first and second optical communication signals having wavelengths in respective first and second spectral bands;
(b) receiving by the OCM, from a wavelength reference (WLREF), the first and second spectral bands;
(c) comparing, by the OCM, the first and second optical communication signals sampled in step (a) with the respective first and second spectral bands received in step (b);
(d) based on the comparison in step (c), determining, by the OCM, if one or more parameters of each of the first and second optical communication signals is operating outside of a predetermined tolerance or range of the one or more parameters for the optical communication signal; and
(e) for each of the first and second optical communication signals determined to be operating outside of the predetermined tolerance or range of the one or more parameters for the optical communication signal in step (d), adjusting the one or more parameters of the optical communication signal sampled by the OCM whereupon the optical communication signal is operating within the predetermined tolerance or range of the one or more parameters of the optical communication signal.

6. The method of claim 5, wherein the adjusting in step (e) is performed via:
an optical amplifier that is programmed, operative and/or configured for amplifying the first and second optical communication signals, wherein the optical amplifier is programmed, operative and/or configured for adjusting the one or more parameters based on the determination by the OCM in step (d); or
a wavelength selective switch (WSS) through which the first and second optical communication signals propagate, wherein the WSS is programmed, operative and/or configured for adjusting the one or more parameters based on the determination by the OCM in step (d); or
a controller that is coupled to the OCM, wherein the controller is programmed, operative and/or configured for causing the one or more parameters to be adjusted based on the determination by the OCM in step (d).

7. The method of claim 5, wherein the first and second spectral bands include two of the following spectral bands: a C-band, an L-band, an S-band, an O-band, an E-band and a U-band.

8. The method of claim 5, wherein the one or more parameters include an optical frequency, an optical power, a spectral power tilt, or some combination of the optical frequency, the optical power and/or the spectral power tilt.

9. A wavelength division multiplexing (WDM) system comprising:
first and second optical transmitters outputting into an input end of one or more optical fibers first and second optical communication signals having wavelengths in respective first and second spectral bands;
first and second optical receivers receiving the first and second optical communication signals;
at least one optical channel monitor (OCM) optically coupled to the one or more optical fibers, the OCM programmed, operative and/or configured for sampling from the one or more optical fibers the first and second optical communication signals; and
a wavelength reference (WLREF) optically coupled to the OCM and programmed, operative and/or configured for outputting to the OCM the first and second spectral bands, wherein:
the OCM is programmed, operative and/or configured for comparing the first and second optical communication signals sampled by the OCM with the respective first and second spectral bands; and
the OCM is programmed, operative and/or configured for determining from the comparison if one or more parameters of each of the first and second optical communication signals is operating outside of a predetermined tolerance or range of the one or more parameters of the optical communication signal, wherein, for each of the first and second optical communication signals determined by the OCM to be operating outside of the predetermined tolerance or range of the one or more parameters of the optical communication signal, adjusting the one or more parameters of the optical communication signal sampled by the OCM whereupon the optical communication signal is operating within the predetermined tolerance or range of the one or more parameters of the optical communication signal.

10. The system of claim 9, wherein the adjusting of the one or more parameters of the optical communication signal sampled by the OCM is performed by:
an optical amplifier that is optically coupled to the one or more optical fibers for amplifying the first and second optical communication signals, wherein the optical amplifier is programmed, operative and/or configured for adjusting the one or more parameters based on the determination by the OCM; or
a wavelength selective switch (WSS) through which the first and second optical communication signals propagate, wherein the WSS is programmed, operative and/or configured for adjusting the one or more parameters based on the determination by the OCM; or
a controller that is coupled to the OCM, wherein the controller is programmed, operative and/or configured for causing the one or more parameters to be adjusted based on the determination by the OCM.

11. The WDM system of claim 10, further including:
a third optical transmitter outputting into the input end of the one or more optical fibers a third optical communication signal, having a wavelength in a third spectral band;
a third optical receiver receiving the third optical communication signal; and
the WLREF optically coupled to the OCM and programmed, operative and/or configured for outputting to the OCM the third spectral band, wherein:
the OCM is programmed, operative and/or configured for comparing the third optical communication signal sampled by the OCM with the third spectral band; and
the OCM is programmed, operative and/or configured for determining from the comparison of the third optical communication signal with the third spectral band if one or more parameters of the third optical communication signal is operating outside of a predetermined tolerance or range of the third optical communication signal, wherein, in response to determining that the third optical communication signal is operating outside of the predetermined tolerance or range of the one or more parameters of the third optical communication signal, adjusting by the optical amplifier, the WSS, or the controller the one or more parameters of the third optical communication signal sampled by the OCM whereupon the third optical communication signal is operating within the predetermined tolerance or range of the one or more parameters of the third optical communication signal.

12. The system of claim 11, further including:
a fourth optical transmitter outputting into the input end of the one or more optical fibers a fourth optical communication signal, having a wavelength in a fourth spectral band;
a fourth optical receiver receiving the fourth optical communication signal;
the WLREF optically coupled to the OCM and programmed, operative and/or configured for outputting to the OCM the fourth spectral band, wherein:
the OCM is programmed, operative and/or configured for comparing the fourth optical communication signal sampled by the OCM with the fourth spectral band; and
the OCM is programmed, operative and/or configured for determining from the comparison of the fourth optical communication signal with the fourth spectral band if one or more parameters of the fourth optical communication signal is operating outside of a predetermined tolerance or range of the fourth optical communication signal, wherein, in response to determining that the fourth optical communication signal is operating outside of the predetermined tolerance or range of the one or more parameters of the fourth optical communication signal, adjusting by the optical amplifier, the WSS, or the controller the one or more parameters of the fourth optical communication signal sampled by the OCM whereupon the fourth optical communication signal is operating within the predetermined tolerance or range of the one or more parameters of the fourth optical communication signal.

13. The system of claim 9, wherein the first and second spectral bands include two of the following spectral bands: a C-band, an L-band, an S-band, an O-band, an E-band and a U-band.

14. The system of claim 9, wherein the one or more parameters include an optical frequency, an optical power, a spectral power tilt, or some combination of the optical frequency, the optical power and/or the spectral power tilt.

15. The system of claim 9, wherein:
the at least one OCM includes two or more OCMs, wherein each OCM is optically coupled to a different section of the one or more optical fibers and is programmed, operative and/or configured for sampling from the one or more optical fibers the first and second optical communication signals;
the WLREF is optically coupled to each OCM and is programmed, operative and/or configured for outputting to each OCM the first and second spectral bands, wherein each OCM is programmed, operative and/or configured for comparing the first and second optical communication signals sampled by the OCM with the respective first and second spectral bands; and
each OCM is programmed, operative and/or configured for determining from the comparison by the OCM if one or more parameters of each of the first and second optical communication signals is operating outside of the predetermined tolerance or range of the one or more parameters of the optical communication signal, wherein, for each of the first and second optical communication signals determined by the OCM to be operating outside of the predetermined tolerance or range of the one or more parameters of the optical communication signal, adjusting the one or more parameters of the optical communication signal sampled by the OCM whereupon the optical communication signal output by the corresponding optical transmitter is operating within the predetermined tolerance or range of the one or more parameters of the optical communication signal.

16. A wavelength division multiplexing (WDM) system comprising:
a wavelength selective switch (WSS) optically coupled between first and second optical fiber bundles;
a first optical channel monitor (OCM1) programmed, operative and/or configured for sampling a first set of optical communication signals having a first set of wavelengths in a first set of spectral bands propagating on a first set of optical fibers of the first optical fiber bundle;
a second optical channel monitor (OCM2) programmed, operative and/or configured for sampling a second set of optical communication signals having a second set of wavelengths in a second set of spectral bands propagating on a second set of optical fibers of the second optical fiber bundle; and
a wavelength reference (WLREF) optically coupled to the OCM1 and the OCM 2, the WLREF programmed, operative and/or configured for outputting to the OCM1 and the OCM2 the first and second sets of spectral bands, wherein:
the OCM1 is programmed, operative and/or configured for comparing the first set of optical communication signals with the first set of spectral bands and for determining from the comparison if one or more parameters of the first set of optical communication signals is operating outside of a predetermined tolerance or range of a set of parameters of the first set of optical communication signals wherein, in response to the OCM1 determining that the first set of optical communication signals is operating outside of the predetermined tolerance or range of the set of parameters of the first set of optical communication signals, adjusting the set of parameters of the first set of optical communication signals whereupon the first set of optical communication signals is operating within the predetermined tolerance or range of the set of parameters of the first set of optical communication signals; and
the OCM2 is programmed, operative and/or configured for comparing the second set of optical communication signals with the second set of spectral bands and for determining from the comparison if one or more parameters of the second set of optical communication signals is operating outside of a predetermined tolerance or range of a set of parameters of the second set of optical communication signals wherein, in response to the OCM2 determining that the second set of optical communication signals is operating outside of the predetermined tolerance or range of the set of parameters of the second set of optical communication signals, adjusting the set of parameters of the second set of optical communication signals whereupon the second set of optical communication signals is operating within the predetermined tolerance or range of the set of parameters of the second set of optical communication signals.

17. The system of claim 16, wherein at least one of the following:
the first and second sets of wavelengths are the same; and
the first and second sets of spectral bands are the same.

18. The system of claim 16, wherein the adjusting of the one or more parameters of each optical communication signal is performed by:
the WSS; or
an optical amplifier that is programmed, operative and/or configured to amplify the optical communication signal; or
a controller that is coupled to an optical transmitter that outputs the optical communication signal, wherein the controller is programmed, operative and/or configured to cause the optical transmitter to adjust the one or more parameters of the optical signal.

19. The system of claim 16, wherein, at least one of the following:
each set of optical communication signals includes at least one optical communication signal;
each set of wavelengths includes at least one wavelength;
each set of spectral bands includes at least one spectral band;
each set of optical fibers includes at least one optical fiber; and
the set of parameters of each set of optical communication signals includes at least one parameter.
